(19) United States
(12) Patent Application Publication
(10) Pub. No.: US 2002/0131102 A1
(43) Pub. Date: Sep. 19, 2002

(54) Optical SN detector

(75) Inventor: Yasuhisa Taneda, Tokyo (JP)

Correspondence Address: YOUNG & THOMPSON, 745 SOUTH 23RD STREET 2ND FLOOR, ARLINGTON, VA, 22202

(73) Assignee: NEC CORPORATION, Tokyo (JP)

(21) Appl. No.: 10/098,425

(22) Filed: Mar. 18, 2002

(30) Foreign Application Priority Data
Mar. 19, 2001 (JP) 2001-078309

(51) Int. Cl. H04B 10/08; H04J 14/02

(52) U.S. Cl. 359/110; 359/124

(57) ABSTRACT

A wavelength-multiplexed light signal and noise light (or amplified spontaneous emission light) generated from an optical amplifier in an optical transmission line, along which the light signal is propagated is inputted to an input part 2. A noise light detector 3 detects the power level of the noise light in a predetermined wavelength range. A monitoring light detector 4 is provided as a stage subsequent to the noise light detector and serves to detect the power level of the light signal. Trouble occurrence in the optical transmission line is detected by computing the optical SN from the light power levels of different wavelength components.

### BACKGROUND OF THE PRESENT INVENTION

This application claims benefit of Japanese Patent Application No. 2001-078309 filed on Mar. 19, 2001, the contents of which are incorporated by the reference.

The present invention relates to optical SN (signal-to-noise ratio) detectors and, more particularly, to optical SN detectors pertaining to the field of optical communication and for detecting the occurrence of a trouble in a transmission line by computing the optical SN as an index of optical signal transmission characteristic deterioration.

In the field of optical communication, wavelength-multiplexing transmission systems are employed to provide increased transmission capacity. Also, high reliability of the transmission system has been required. For instance, it is demanded to be able to detect that neither deterioration nor interruption of transmitted signal due to any abnormality in the transmitting part on the opposite station side or any trouble in optical fiber and relay constituting undersea transmission section. Prior art techniques pertaining to such technical field are disclosed in, for instance, Japanese Patent Laid-Open No. 5-211482 entitled “Optical Amplifier/Relays”, Japanese Patent Laid-Open No. 5-276120 entitled “Optical Amplifier Characteristic Evaluation Method and Optical Relay Transmission System”, Japanese Patent Laid-Open No. 10-336118 entitled “Optical Direct Amplifier” and Japanese Patent Laid-Open No. 2000-183434 entitled “High Accuracy Optical Output Monitor”.

FIG. 12 is a schematic showing a prior art optical receiver. In the optical receiver 100, a wavelength-multiplexed light signal having been attenuated while being propagated in a transmission line, is amplified in an optical amplifier 101 and then branched by an optical coupler 102 and AWGs (Arrayed Waveguide Gratings) 103 and 104 to wavelength components. For monitoring the power level of ASE (amplified spontaneous emission) which is inevitable noise light generated from the optical amplifier 101 in the transmission line by utilizing the fact that the monitored power level is increased in the event of the breakage of the transmission line, a light-receiving element 108 is connected to a vacant port 107 outputting no light signal among AWG output ports 105 and 106. The detected voltage outputted from the light-receiving element 108 and a reference voltage (ref. voltage) are compared in a comparator 109 for detecting the trouble occurrence.

FIG. 13 is a block diagram showing another prior art optical receiver 200. In this optical receiver 200, a wavelength-multiplexed light signal having been attenuated while being propagated in a transmission line, is amplified in an optical amplifier 201, and then fed to an optical coupler 205, which passes a light signal of a particular wavelength (or channel wavelength) to an O/E (optical-to-electric) converter 208 while blocking light signals of the other wavelengths. Optical couplers 202 and 206 are provided preceding to and succeeding to the optical filter 205. An optical filter 203 transmitting the ASE wavelengths and an optical receiving element 204 are connected to the first-stage optical coupler 202. The optical receiving element 204 and an optical receiving element 207 connected to the optical coupler 206 monitor the ASE component and the light signal component. The detected voltages from the two elements 204 and 207 are compared for the trouble occurrence detection.

The above prior art techniques, however, have the following problems. The former optical receiver 100, although simple in construction, monitors the ASE power level alone. Therefore, power level variation of the input to the optical receiver 100 results in erroneous detection. In addition, the ASE power level is increased in different trends or manners at the time of the light signal input and at the time of the transmission line breakage event in dependence on various factors such as the distance of transmission and the wavelength. Therefore, the reference voltage of the comparator 109 can not be readily preset.

The latter optical receiver 200 has the O/E comparator 208 provided on the most output side, and it is thus an effective means in the case when the light signal comprises a single wave. However, in the wavelength-multiplexing system, only a single wave having transmitted through the optical filter 205 is monitored. Therefore, when the pertinent transmitting laser on the opposite station side fails to provide output due to such cause as a trouble or a connector detachment, the transmission line is erroneously detected to be abnormal although other channel signals are normally transmitted. It is possible to provide a plurality of optical receivers 200, but doing so is not efficient.

### SUMMARY OF THE INVENTION

An object of the present invention is to provide an optical SN detector, in which a plurality of signal components and a noise component (i.e., ASE light component) are always detected during propagation of wavelength-multiplexed light signal along an optical transmission line with multiple optical amplifier stages connected thereto, so that in the event of reception of a deteriorated SN light signal it detects the occurrence of a trouble in the optical transmission line independently of the received power level.

According to an aspect of the present invention, there is provided an optical SN detector comprising a input part for inputting a wavelength-multiplexed light signal and noise light (or amplified spontaneous emission light) generated from an optical amplifier in an optical transmission line, along which the light signal is propagated, a noise light detector for detecting the power level of the noise light in a predetermined wavelength range, and a monitoring light detector provided as a stage subsequent to the noise light detector and serving to detect the power level of the light signal, trouble occurrence in the optical transmission line being detected by computing the optical SN from the light power levels of different wavelength components.

According to another aspect of the present invention, there is provided an optical SN detector comprising a input part for inputting a wavelength-multiplexed light signal and noise light (or amplified spontaneous emission light) generated from an optical amplifier in an optical transmission line, along which the light signal is propagated, a noise light detector, including an optical isolator, an optical coupler, a fiber grating (FBG) for reflecting a predetermined wavelength range of the input light to the input part, and a light-receiving element for detecting the power level of the reflected light beam from the FBG via the optical coupler, for detecting the power level of the noise light in a predetermined wavelength range, and a monitoring light detector, including an optical isolator, an optical coupler, a fiber grating (FBG) for reflecting a predetermined wavelength range of the input light to the input part, and a light-receiving element for detecting the power level of the reflected light beam from the FBG via the optical coupler, provided as a stage subsequent to the noise light detector and serving to detect the power level of the light signal, trouble occurrence in the optical transmission line being detected by computing the optical SN from the light power levels of different wavelength components.

The optical SN is discriminated on the basis of signals obtained by predetermined gain amplifying detection signals from the light-receiving element of the noise light and monitoring light detectors. The optical SN is discriminated on the basis of signals obtained by predetermined gain amplifying detection signals from the light-receiving element of the noise light and monitoring light detectors by using a divider circuit. The optical SN detector comprises a plurality of FBGs with different reflection wavelengths, reflection light beams from the plurality of FBGs being inputted to a single light-receiving element to reduce internal passing loss, the optical SN detector being thereby applicable to a wavelength-multiplexed optical transmission system with freedom from erroneous detection even in the event of blocking of only a particular monitoring light wavelength. The noise light and monitoring light detectors each include an optical isolator, an optical circulator, an FBR for reflecting a predetermined wavelength range of the input light to the input part, and a light-receiving element for detecting the power level of the reflected light beam from the FBG via the optical circulator. The FBG reflection wavelengths of the noise light and monitoring light detectors conform to an ITU-T grid. The optical SN detector further comprises an input light power level detector provided as a stage subsequent to monitoring light detector for preventing erroneous operation at the time of absence of any input light.

According to other aspect of the present invention, there is provided a method for detecting SN of a wavelength-multiplexed light signal and noise light generated from an optical amplifier in an optical transmission line, comprising: detecting a power level of the noise light in a predetermined wavelength range, detecting a power level of the light signal, and detecting trouble occurrence in the optical transmission line computing the optical SN from the light power levels of different wavelength components.

Other objects and features will be clarified from the following description with reference to attached drawings.

### BRIEF DESCRIPTION OF THE DRAWINGS

FIG. 1 is a block diagram showing the construction of a first embodiment of the optical SN detector according to the present invention;

FIG. 2 shows the detailed construction of the optical SN detecting part 6 shown in FIG. 1;

FIG. 3 is a measuring system for evaluating the optical SN detector 1A according to the present invention;

FIGS. 4(A) and 4(B) are views showing optical spectrum waveform deterioration measured in the optical spectrum analyzer 12 when the input light to the optical receiver 7 is attenuated in power level;

FIG. 5 shows the output voltage of the divider IC 63 at this time;

FIG. 6 is a graph showing the detection voltages in the case when one monitoring light wave is blocked due to such case as detachment of the pertinent channel optical connector or laser trouble in the opposite station side and the case when two monitoring light waves are present;

FIG. 7 is a graph showing a detection voltage characteristic in case when the output cables from relays on the transmission line at a closest, an intermediate and a most remote point from the optical receiver are broken;

FIG. 8 is a view showing the construction of a second embodiment of the optical SN detector according to the present invention;

FIG. 9 is a view showing the construction of a third embodiment of the present invention;

FIG. 10 is a view showing the construction of a fourth embodiment of the optical SN detector according to the present invention;

FIG. 11 is a view showing the construction of a fifth embodiment of the optical SN detector according to the present invention;

FIG. 12 is a schematic showing a prior art optical receiver; and

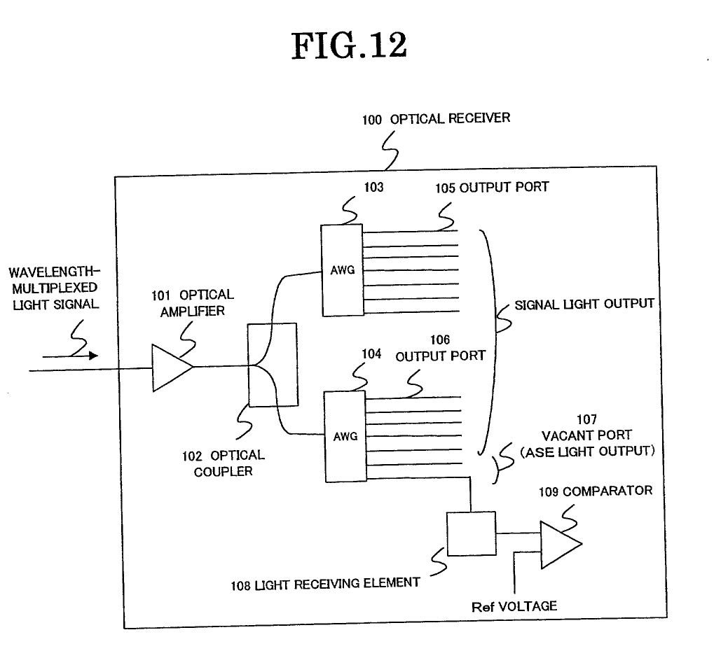

FIG. 13 is a block diagram showing another prior art optical receiver 200.

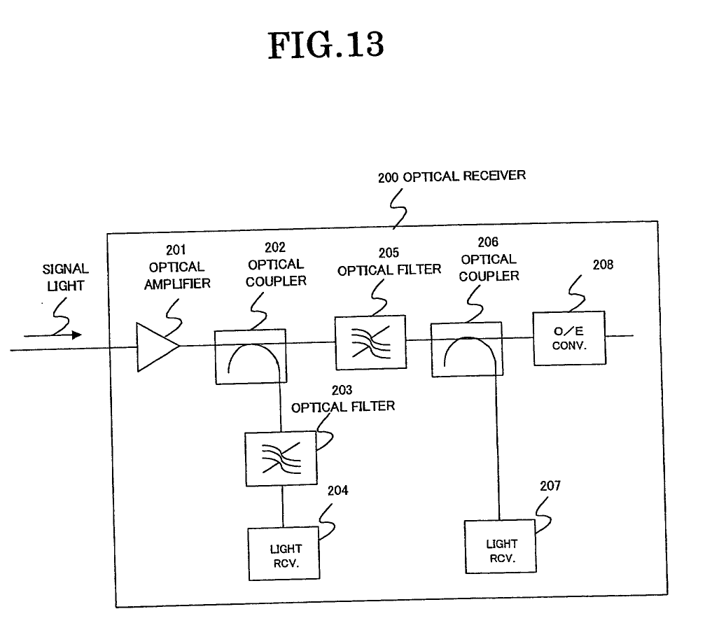

### PREFERRED EMBODIMENTS OF THE INVENTION

Preferred embodiments of the present invention will now be described with reference to the drawings.

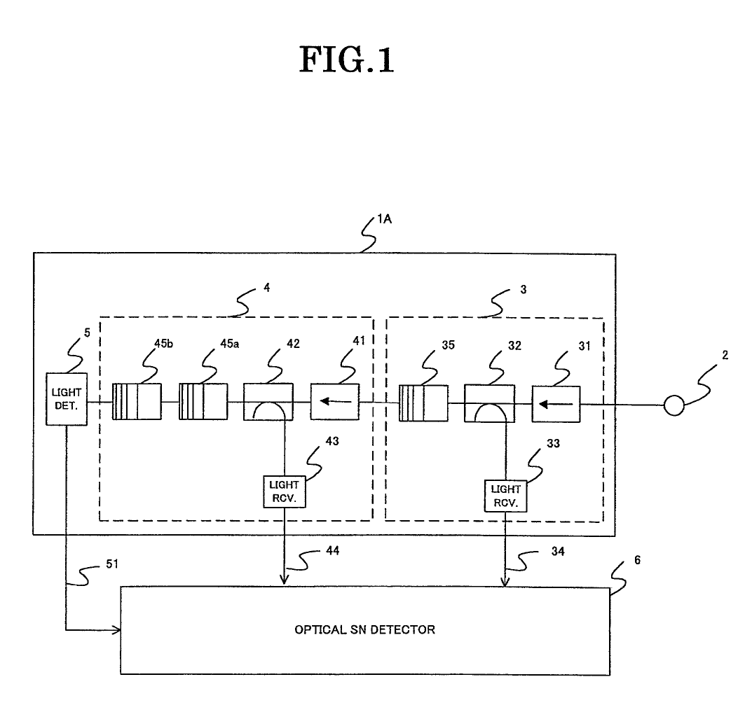

FIG. 1 is a block diagram showing the construction of a first embodiment of the optical SN detector according to the present invention. This optical SN detector 1A comprises a input part 2, a noise light detector 3, a monitoring light detector 4 and an input light power level detector 5. The noise light detector 3 includes a light isolator 31, a 3-dB optical coupler 32, a light-receiving element (i.e., photo-diode) 33 and a fiber grating (FBG) 35. The light-receiving element 33 outputs a noise component detection signal 34 to an optical SN detecting part 6. The monitoring light detector 4 includes a light isolator 41, an optical coupler 42, a light-receiving element (i.e., photo-diode) 43 and a pair of fiber gratings (FBGs) 45a and 45b. The light-receiving element 43 outputs a monitoring light component detection signal 44 to the optical SN detector 6.

The input light to the input part 2 is led through the light isolator 31 and the 3-dB optical coupler 32 to the FBG 35, which has a reflection center wavelength of 1,538.98 nm and an FWHM (full-width at half-maximum) of 0.26 nm. The reflection center wavelength of the FBG 35 is slightly deviated from the optical range of wavelength multiplexed light signal toward the short wavelength side, and the FBG 35 always reflects the ASE wavelength component to the 3-dB optical coupler 32. The 3-dB optical coupler 32 branches the reflected ASE wavelength component to provide two branched light beams. One branched light beam is led to the light-receiving element (which is specifically InGaAs-PIN photo-diode) 33 for ASE light power level detection. therein. The other branched light beam is blocked by the light isolator 31 lest it should has adverse effects on the outside of the optical SN detector 1A. The input light other than the predetermined ASE wavelength component, having been transmitted through the FBG 35, is inputted to the monitoring light detector 4, and is led through the light isolator 41 and the 3-dB optical coupler 42 to the paired FBGs 45a and 45b. The FBGs 45a and 45b have an FWHM of 0.26 nm and reflection center wavelengths of 1,564.27 and 1,565.09 nm, respectively. The monitoring light beams of different wavelengths reflected by the FBGs 45a and 45b, respectively, are led back to the 3-dB optical coupler 42 for branching therein into two branched light beams. One branched light beam is led to the InGaAs-PIN photo-diode 43 for two-wavelength monitoring light power level detection. The other branched light beam is blocked by the light isolator 41 lest it has adverse effects on the noise light detector 3.

In this embodiment, a plurality of FBGs 45 are employed for the following reason. If only a single FBG is used, in the event of occasional blocking of the pertinent monitoring light wave due to some cause (for instance, light connector detachment or a trouble in the laser), the ASE wavelength component is inputted to the photo-diode 43, thus resulting in erroneous detection that the transmission line is abnormal. Thus, it is presumable that the possibility that two monitoring light waves are simultaneously blocked is very low. For preventing the erroneous detection, a plurality of FBGs 45 are thus provided to input monitoring light beams for a plurality of channels to the photo-diode 43. The input light having been transmitted through the monitoring light detector 4 is inputted to the input light power level detector (for instance a light-receiving element such as a photo-diode) 5. Although this input light lacks the wavelength components reflected by the FBGs 35, 45a and 45b, its power level is regarded to be the power level of the input light to the optical SN detector 1A. The detection signals 34, 44 and 51 from the photo-diodes 33, 43 and 5, respectively, are inputted to the optical SN detecting part 6.

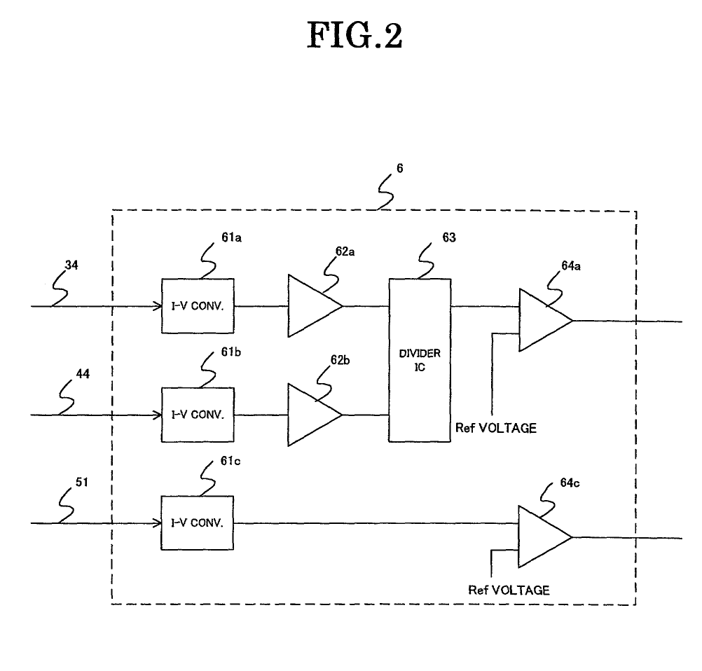

FIG. 2 shows the detailed construction of the optical SN detecting part 6 shown in FIG. 1. As shown, the optical SN detecting part 6 includes a current-to-voltage (I-V) converters 61a to 61c, amplifiers 62a and 62b to which the outputs of the I-V converters 61a and 61b, respectively, are inputted, a divider IC (semiconductor integrated circuit) 63, a comparator 64a connected to the output side of the divider IC 63 and serving to compare the output voltage thereof with a reference voltage (ref. voltage), and a comparator 64c for comparing the output voltage of the I-V converter 61c with the reference voltage. In the optical SN detector 6, the input currents 34 and 44 are converted in the I-V converters 61a and 61b, which are each constituted by an operational amplifier and a resistor), to voltage outputs. These voltage outputs are amplified to about ten times in the amplifiers 62a and 62b. The amplifier outputs are inputted with the sides of the detection signals 34 and 44 as numerator and denominator, respectively, to the divider IC 63. As the divider IC 63 is used an IC (Model AD534KD) manufactured by Analog Device Co., Ltd. in USA. The divider IC 63 has a characteristic that it amplifies the quotient to ten times and that the output is saturated at the applied voltage level of 12 V. The output voltage range of the divider IC 63 is thus 0 to 12 V. The output voltage of the divider IC 63 is inputted to the comparator 64a for comparison with the reference voltage (ref. voltage) and detection of abnormality of the transmission line. When no light is inputted to the optical SN detector 1A, the divider IC 63 is not normally operated. To evade this, the InGaAs-PIN photo-diode is used as the input light power level detector 5.

The divider IC operates normally in its quotient range of “0” to “1”. Thus, opposite to the intrinsic optical SN, the ASE light and monitoring light power level detection voltages are inputted to the numerator and denominator sides, respectively, of the divider IC. Normally, the quotient of the divider IC is thus in the neighborhood of “0”. In the event of optical cable breakage in the transmission line, the light signal is no longer propagated, and the sole wide band ASE light that is inevitably generated from the optical amplifiers is inputted to the optical SN detecting part. The numerator and denominator voltages of the divider IC thus become substantially equal, and the quotient thereof is saturated to “1”.

When the noise light and monitoring light power levels are controlled while holding the optical SN constant, the detection voltage is always constant because the ratio is obtained in the divider IC. It is thus possible to detect the optical SN independently of the input light power level.

It is possible to compute the optical SN of each monitoring light beam independently by using a photo-diode for each monitoring lightwave. In this case, however, such problems as cost increase, module size increase, detection voltage error increase due to power level reduction of the input to the photo-diode are posed. In the optical SN detector according to the present invention, a plurality of monitoring light beams are inputted to a single photo-diode to reduce the internal passing loss in the module and prevent erroneous detection even in the event of one monitoring light wave due to some cause.

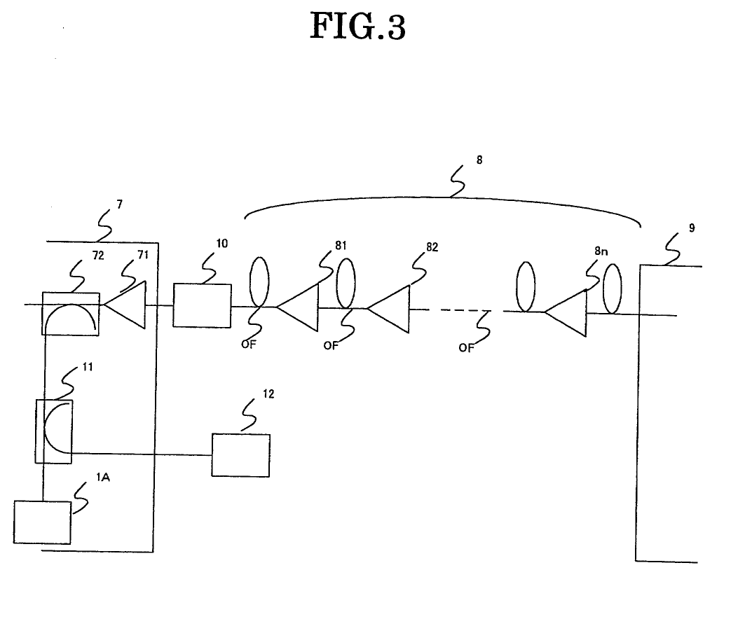

The operation of the optical SN detector 1A according to the present invention will be described. FIG. 3 is a measuring system for evaluating the optical SN detector 1A according to the present invention. It is assumed that a wavelength-multiplexed light signal with a light signal band of 1,539.37 to 1,565.50 nm and a wavelength interval of 50 GHz is outputted from an optical transmitter 9 to an undersea transmission line 8. The undersea transmission line 8 is constituted by optical fiber (OF) and relays 8n (n being 1, 2, . . . , n). The relay interval is about 40 km. An optical attenuator 10 for evaluation is inserted preceding to an optical receiver 7 to attenuate the power level of the input to the optical receiver 7 so as to deteriorate the optical SN. In the optical receiver 7, for the optical SN monitoring the light signal having been attenuated in the undersea transmission line is amplified in an optical amplifier 71 and then partly led via a 10-dB optical coupler 2 to the optical SN detector 1A. For monitoring the spectrum and power level of the input light to the optical SN detector 1A, the optical receiver 7 further includes a 10-dB optical coupler 11, which is connected to an optical spectrum analyzer (or an optical power meter) 12.

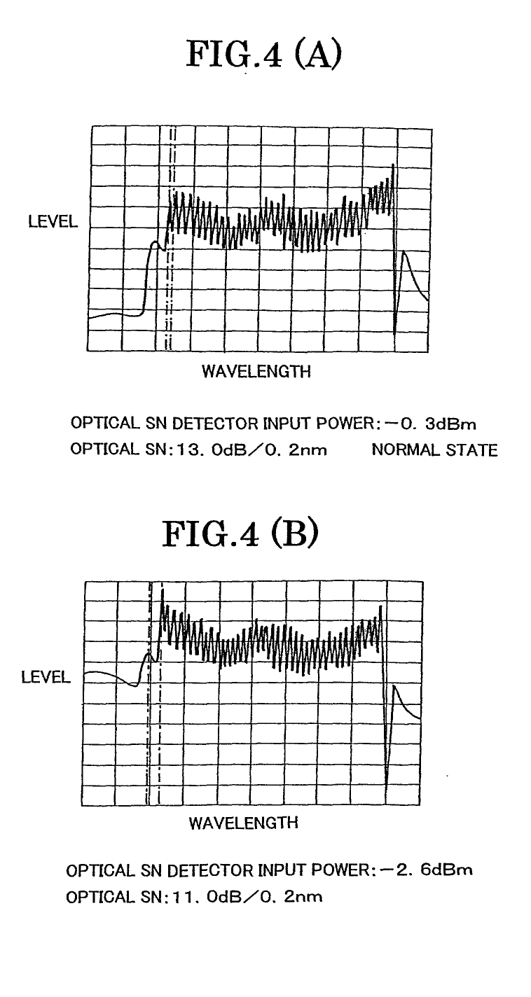

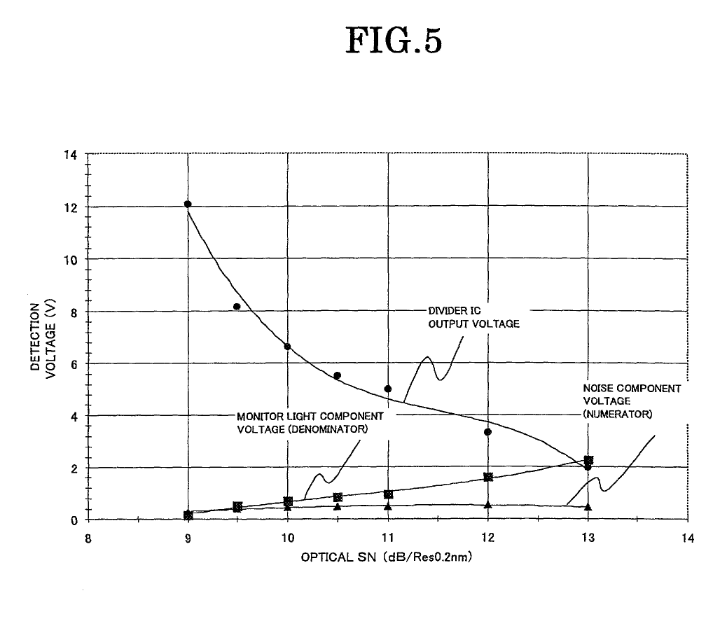

FIGS. 4(A) and 4(B) are views showing optical spectrum waveform deterioration measured in the optical spectrum analyzer 12 when the input light to the optical receiver 7 is attenuated in power level. When the input is at a normal power level of −0.3 dBm as shown in FIG. 4(A), the optical SN is 13 dB/Res. 0.2 nm. On the other hand, when the input is at a power level of −2.6 dBm as shown in FIG. 4(B), the optical SN is deteriorated to 9.0 dB/Res. 0.2 nm. FIG. 5 shows the output voltage of the divider IC 63 at this time. As shown, the output voltage of the divider IC 63 is increased from 0.2 V to the upper limit of 12.0 V. It will be seen that this voltage is a detection of the optical SN variation.

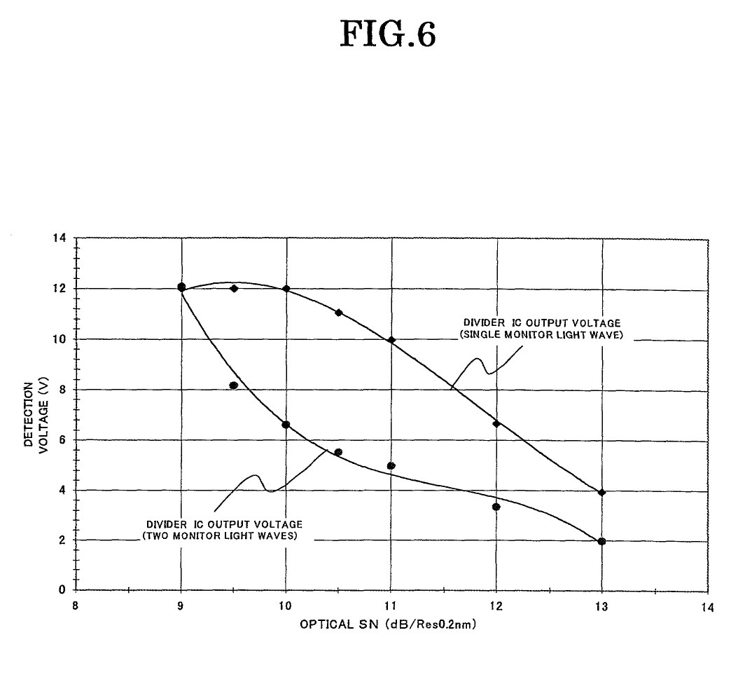

FIG. 6 is a graph showing the detection voltages in the case when one monitoring light wave is blocked due to such case as detachment of the pertinent channel optical connector or laser trouble in the opposite station side and the case when two monitoring light waves are present. As is seen from the Figure, the detection voltage is higher in the one monitoring light wave case than in the two wave case provided the optical SN is the same. Therefore, if the reference voltage (ref. voltage) is preset to be too low, in the event of blocking of one monitoring light wave, erroneous detection of transmission line abnormality is produced despite the fact that the other channel signals are being normally transmitted. This means that the reference voltage should be preset by taking the one monitoring light wave case into considerations.

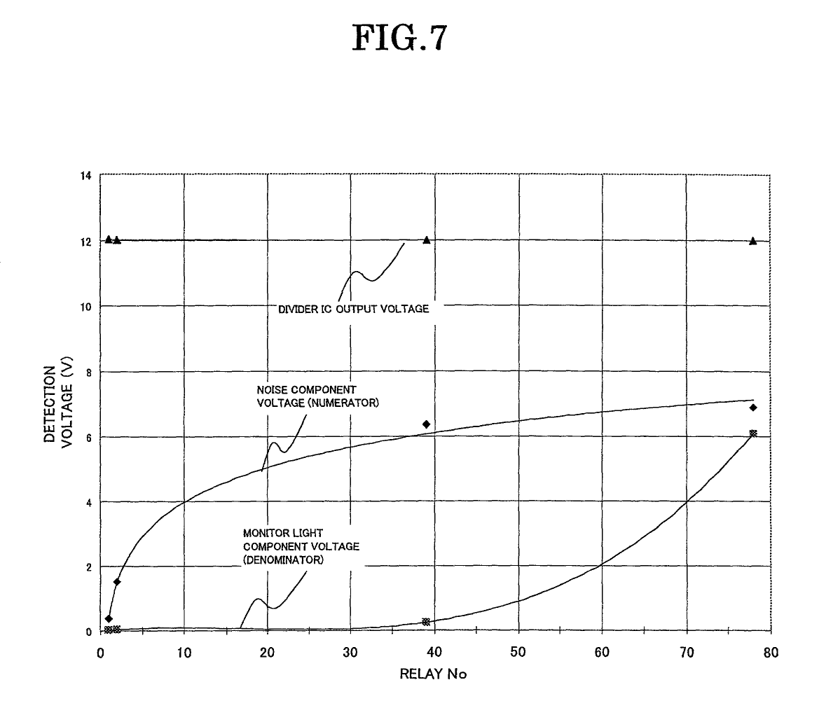

FIG. 7 is a graph showing a detection voltage characteristic in case when the output cables from relays on the transmission line at a closest, an intermediate and a most remote point from the optical receiver are broken. As is obvious from the Figure, irrespective of blocking of the output from any relay on the transmission line, the monitoring light component voltage (i.e., denominator of the divider IC) is lower than the noise component voltage (i.e., numerator), and the output voltage of the divider IC 63 is always saturated (at 12 V). Thus, by presetting the reference voltage in a range of 4 to 10 V by taking the detection voltage level in the one monitoring light wave case as shown in FIG. 6 into considerations, it is possible to detect the transmission line abnormality without possibility of erroneous detection.

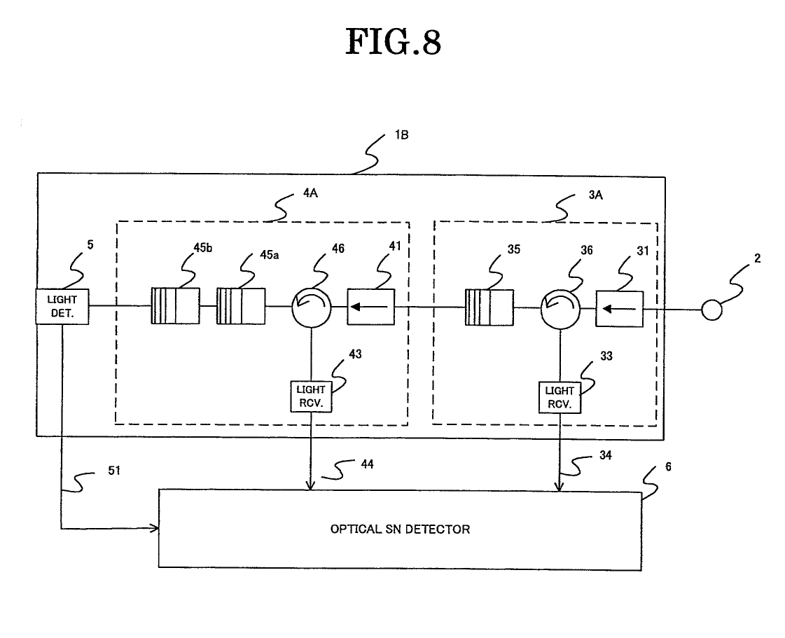

FIG. 8 is a view showing the construction of a second embodiment of the optical SN detector according to the present invention. For the sake of the brevity, component elements like those in the preceding first embodiment are designated by like numerals and symbols, and the description will be made mainly in connection with the difference without giving duplicate description of the corresponding elements. This optical SN detector 1B employs optical circulators 36 and 46 in lieu of the optical coupler 32 in noise light detector 3A and the optical coupler42 in monitoring light detector 4A, respectively. When light signal reciprocates through an optical coupler, the light power level is extremely reduced. This is improved by the employment of the optical circulators 36 and 46. This embodiment is thus effective for the case where input light power level is low or the case where optical components are connected in multiple stages for reducing the internal passing loss in the module.

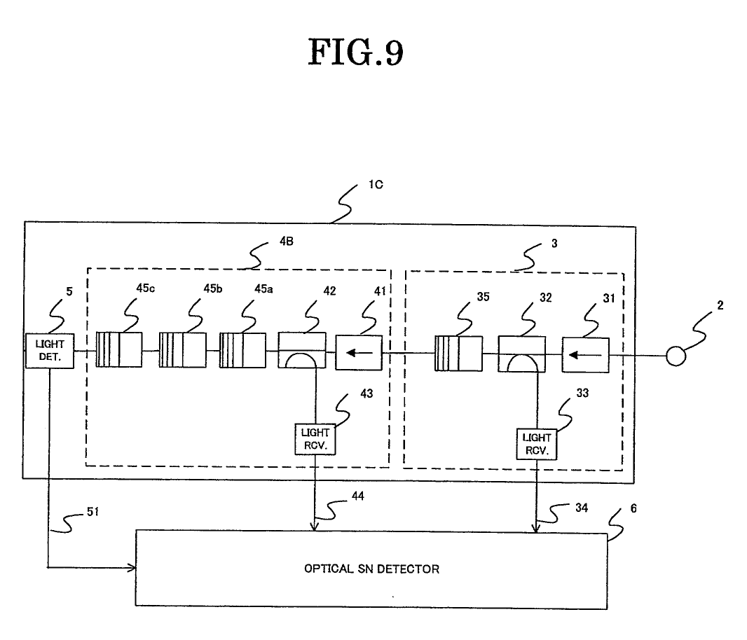

FIG. 9 is a view showing the construction of a third embodiment of the present invention. This optical SN detector IC is different from the first embodiment of the optical SN detector 1A in that the monitoring light detector 4B includes three FBGs 45a to 45c for reflecting three waves of the monitoring light beam. This embodiment is effective for the case of increasing the power level of the input light to the photo-diode 43 or the case of reducing the detection voltage variation at the time of blocking of a particular monitoring light wave. It is further possible to provide multiple stages of FBGs 45 and 35.

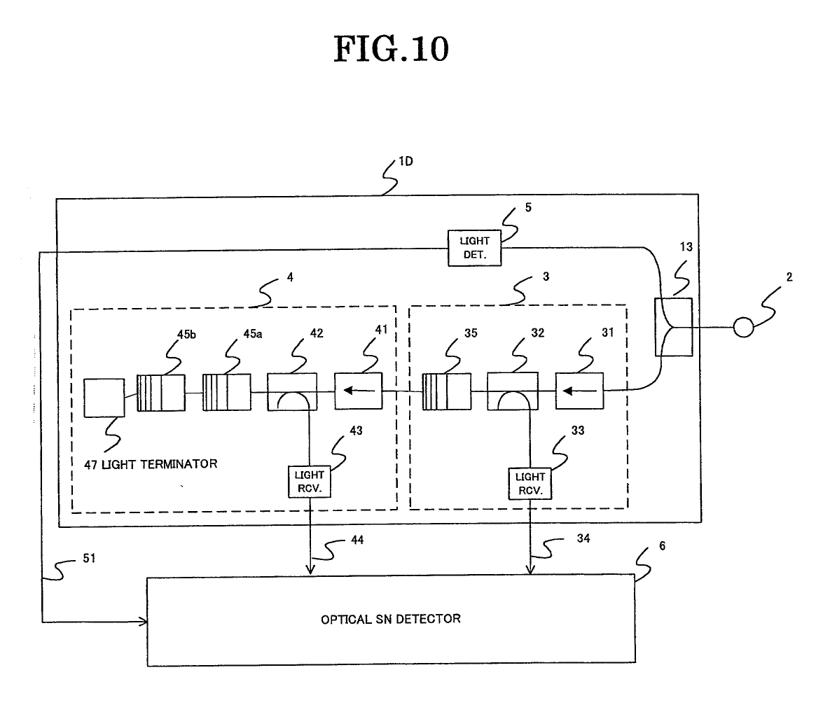

FIG. 10 is a view showing the construction of a fourth embodiment of the optical SN detector according to the present invention. In this optical SN detector 1D, the input part includes an optical coupler 13 for input light power level monitoring. Also, the monitoring light detector 4 further includes a light terminator 47 as a stage subsequent to the FBGF 45b.

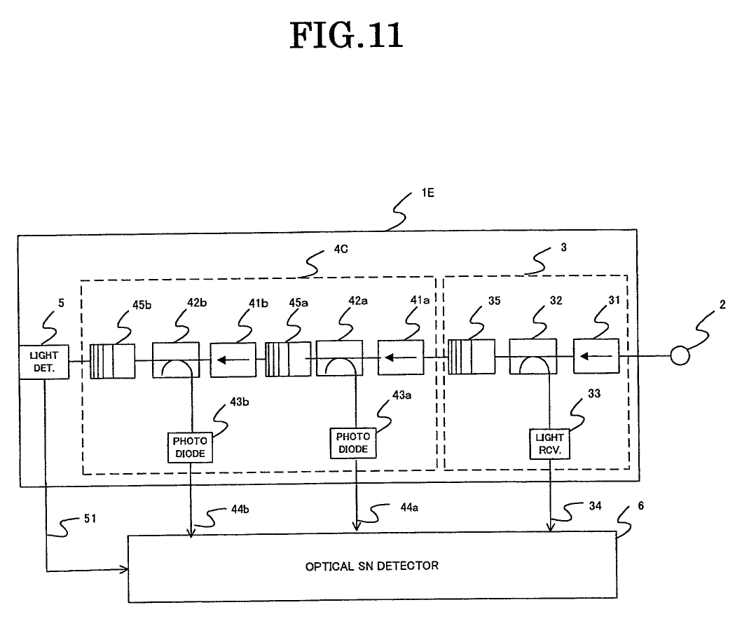

FIG. 11 is a view showing the construction of a fifth embodiment of the optical SN detector according to the present invention. In this optical SN detector 1E, photo-diodes 43a and 43b are provided for the FBGs 45a and 45b, respectively, in the monitoring light detector 4C such that their detection signals 44a and 44b are inputted to the optical SN detecting part 6. Optical isolators 41a and 41b and optical couplers 42a and 42b are further additionally employed, giving rise to cost increase and further light power level attenuation. On the merit side, however, it is possible to detect the optical SN of each monitoring light wave. As described before in connection with the second embodiment, it is possible to employ optical circulators 36 and 46 in lieu of the optical couplers 32 and 42.

While the construction and operation of the various embodiments of the optical SN detector according to the present invention have been described above in details, these embodiments are given as mere examples of the present invention without any sense of limiting the present invention. For example, the wavelengths of the ASE light and monitoring light waves are appropriately preset in dependence on the transmission line characteristics and the construction of the optical transmitter, and the wavelengths noted above are by no means limitative. Particularly, while the ASE light and monitoring light wavelengths were described to be present at the opposite ends of the signal wavelength range, their presetting such as to be adjacent to each other permits more accurate optical SN detection. Furthermore, since the optical power level detection is done in a flat range at the time of the relay cable breakage, a wide band optical spectrum shape need not be considered, thus facilitating the design.

As has been described in the foregoing, the optical SN detector according to the present invention has the following pronounced practical effects. By using the optical SN detector according to the present invention, it is possible to detect trouble occurrence in an optical transmission line having optical amplifiers connected in multiple stages. This is so because the fact that the optical SN of light signal is deteriorated at the trouble occurrence time is utilized for always monitoring the ASE component and light signal power levels and discriminating the optical SN by using the divider IC.

Changes in construction will occur to those skilled in the art and various apparently different modifications and embodiments may be made without departing from the scope of the present invention. The matter set forth in the foregoing description and accompanying drawings is offered by way of illustration only. It is therefore intended that the foregoing description be regarded as illustrative rather than limiting.

What is claimed is:

1. An optical SN detector comprising a input part for inputting a wavelength-multiplexed light signal and noise light (or amplified spontaneous emission light) generated from an optical amplifier in an optical transmission line, along which the light signal is propagated, a noise light detector for detecting the power level of the noise light in a predetermined wavelength range, and a monitoring light detector provided as a stage subsequent to the noise light detector and serving to detect the power level of the light signal, trouble occurrence in the optical transmission line being detected by computing the optical SN from the light power levels of different wavelength components.

2. An optical SN detector comprising a input part for inputting a wavelength-multiplexed light signal and noise light (or amplified spontaneous emission light) generated from an optical amplifier in an optical transmission line, along which the light signal is propagated, a noise light detector, including an optical isolator, an optical coupler, a fiber grating (FBG) for reflecting a predetermined wavelength range of the input light to the input part, and a light-receiving element for detecting the power level of the reflected light beam from the FBG via the optical coupler, for detecting the power level of the noise light in a predetermined wavelength range, and a monitoring light detector, including an optical isolator, an optical coupler, a fiber grating (FBG) for reflecting a predetermined wavelength range of the input light to the input part, and a light-receiving element for detecting the power level of the reflected light beam from the FBG via the optical coupler, provided as a stage subsequent to the noise light detector and serving to detect the power level of the light signal, trouble occurrence in the optical transmission line being detected by computing the optical SN from the light power levels of different wavelength components.

3. The optical SN detector according to one of claims 1 and 2, wherein the optical SN is discriminated on the basis of signals obtained by predetermined gain amplifying detection signals from the light-receiving element of the noise light and monitoring light detectors.

4. The optical SN detector according to one of claims 1 and 2, wherein the optical SN is discriminated on the basis of signals obtained by predetermined gain amplifying detection signals from the light-receiving element of the noise light and monitoring light detectors by using a divider circuit.

5. The optical SN detector according to claim 1 or 2, which comprises a plurality of FBGs with different reflection wavelengths, reflection light beams from the plurality of FBGs being inputted to a single light-receiving element to reduce internal passing loss, the optical SN detector being thereby applicable to a wavelength-multiplexed optical transmission system with freedom from erroneous detection even in the event of blocking of only a particular monitoring light wavelength.

6. The optical SN detector according to claim 1, wherein the noise light and monitoring light detectors each include an optical isolator, an optical circulator, an FBR for reflecting a predetermined wavelength range of the input light to the input part, and a light-receiving element for detecting the power level of the reflected light beam from the FBG via the optical circulator.

7. The optical SN detector according to claim 1 or 2, wherein the FBG reflection wavelengths of the noise light and monitoring light detectors conform to an ITU-T grid.

8. The optical SN detector according to claim 1 or 2, which further comprises an input light power level detector provided as a stage subsequent to monitoring light detector for preventing erroneous operation at the time of absence of any input light.

9. A method for detecting SN of a wavelength multiplexed light signal and noise light generated from an optical amplifier in an optical transmission line, comprising:
detecting a power level of the noise light in a predetermined wavelength range,
detecting a power level of the light signal, and
detecting trouble occurrence in the optical transmission line computing the optical SN from the light power levels of different wavelength components.
